(19) United States
(12) Patent Application Publication
(10) Pub. No.: US 2006/0217959 A1
(43) Pub. Date: Sep. 28, 2006

(54) Translation processing method, document processing device and storage medium storing program

(75) Inventors: Teruka Saito, Ashigarakami-gun (JP); Toshiya Koyama, Ashigarakami-gun (JP); Masakazu Tateno, Ashigarakami-gun (JP); Takashi Nagao, Ashigarakami-gun (JP); Masayoshi Sakakibara, Ebina-shi (JP); Kei Tanaka, Ashigarakami-gun (JP); Kotaro Nakamura, Minato-ku (JP); Xinyu Peng, Ebina-shi (JP)

Correspondence Address: OLIFF & BERRIDGE, PLC, P.O. BOX 19928, ALEXANDRIA, VA, 22320, US

(73) Assignee: Fuji Xerox Co., Ltd., Tokyo (JP)

(21) Appl. No.: 11/218,684

(22) Filed: Sep. 6, 2005

(30) Foreign Application Priority Data
Mar. 25, 2005 (JP) 2005-090202

(51) Int. Cl. G06F 17/28

(52) U.S. Cl. 704/2

(57) ABSTRACT

In a translation processing method, a document is input; characteristic information is extracted from the input document; a translation style is selected according to the characteristic information; and the input document is translated using the selected translation style.

### BACKGROUND OF THE INVENTION

1. Field of the Invention

The present invention relates to technologies for improving the accuracy of translation processing.

2. Description of the Related Art

With the arrival of the era of global communication, so-called machine translation has flourished wherein, using a computer, a text in a particular language is translated into another language by analyzing the structure of a document using dictionary data and a predetermined algorithm and replacing characters (phrases) with other characters (phrases).

When using machine translation, there is the advantage that translation processing can be performed for a large quantity of documents extremely quickly, but on the other hand there is the disadvantage that ordinarily, the quality of the documents after translation is not very high. In the translation processing stage, the translation style (for example, the dictionary data used and the translation processing algorithm) cannot be flexibly changed according to the content of the document (business document or technical document, etc.), and as a result, phrases of the source text are replaced in the text by inappropriate phrases.

The present invention has been made in view of the above circumstances, and provides a document processing device that can improve the quality of translation.

### SUMMARY OF THE INVENTION

In order to address the issues described above, the present invention provides a translation processing method that includes: inputting a document; extracting characteristic information from the input document; selecting a translation style according to the characteristic information; and translating the input document using the selected translation style.

### BRIEF DESCRIPTION OF THE DRAWINGS

Embodiments of the present invention will be described in detail based on the following figures, wherein:

FIG. 1 is a block diagram that shows a functional configuration of a document processing device 1 according to an embodiment of the present invention;

FIG. 2 is a drawing illustrating the flow of processing that registers the document characteristic information executed in the document processing device 1;

FIG. 3 is a drawing that shows examples of a manuscript for registration;

FIG. 4 is a drawing illustrating the processing that extracts character information and non-character information from the document;

FIG. 5 is a drawing illustrating the characteristic information for specifying a manuscript type;

FIG. 6 is a drawing that shows the content of a table Tc wherein the characteristic information is associated with the document type;

FIG. 7 is a drawing illustrating the flow of the translation processing executed in the document processing device 1; and

FIG. 8 is a drawing that shows the content of a table Tr that is referenced when determining the translation style.

### DETAILED DESCRIPTION OF THE INVENTION

Below follows a description of an embodiment according to the present invention, with reference to the drawings.

### Embodiment

FIG. 1 is a block diagram that shows a functional configuration of a document processing device 1 according to an embodiment of the present invention. As shown in FIG. 1, the document processing device 1 includes a control unit 10, a memory 11, an input unit 12, an operating unit 13, a display unit 14, and an output unit 15. The control unit 10 is provided with a control processor such as a CPU, and controls various parts of the document processing device 1. The control unit 10 also has a layout analysis unit 101, a character information separation unit 102, a character information discrimination unit 103, a non-character information discrimination unit 104, a type determination unit 105, and a translation processing unit 106. The layout analysis unit 101 performs layout analysis of a document in the form of image data read by the input unit 12, using a predetermined algorithm, and determines the layout structure of the document. Specifically, it extracts the size and arrangement of headings, columns, and the size and location of headers and footers. The character information separation unit 102 judges whether or not characters and objects other than characters (such as inserted pictures and ruled lines) are included in the document, and when there are objects other than characters, separates the document into character regions and non-character regions. The character information discrimination unit 103 performs a predetermined character discrimination process for the character portion separated and extracted by the character information separation unit 102, and extracts character information (letters, words, and phrases). The non-character information discrimination unit 104 performs image processing such as R/V (raster/vector) conversion for the region of the non-character portion separated and extracted by the character information separation unit 102, and generates vector information reflecting the characteristics of the region. The type determination unit 105 compares the characteristics extracted from the target document using a predetermined comparison algorithm to the characteristic information stored in the memory 11, and by determining their similarity, specifies the type of document. By performing substitution processing of the character information extracted from the document according to the specified document type and using dictionary data stored in the memory 11 or a predetermined algorithm, the translation processing unit 106 translates the language of that document to a different language designated by the user. The details of the processing performed by the control unit 10 will be stated below. The functions of these various parts realized by the control unit 10 may be realized by various independent processors, or they may be realized by, for example, one processor executing software that realizes the above functions.

The memory 11 is a storage device such as RAM, ROM, or a hard disk, and besides storing dictionary data or other reference data necessary when performing the processing described above in the control unit 10, it also stores a table Tc (details stated below) wherein document characteristic information is stored in correspondence with the document type, and a table Tr (details stated below) describing a translation style that should be applied for the identified document type.

The input unit 12 is a scanner device or the like that reads a manuscript printed on paper or the like as digital image data and supplies it to the control unit 10 and the memory 11. The operating unit 13 is an input device such as a keyboard or a mouse, with which the user of the document processing device 1 can designate a translation target document, various instructions related to registration of the translation style, and other necessary information. The input instructions and information are supplied to the control unit 10. The display unit 14 is constituted from a display device (not shown in the drawings) such as a graphics processor (not shown in the drawings) and liquid crystal display, and shows the document and messages to the user on a display under directions from the control unit 10. By inputting various instructions from the input unit 12 while looking at the display unit 14, the user causes the various processing described above to be executed by the document processing device 1. The output unit 15 is a printer for printing the manuscript after edit processing on paper or the like, a communications interface for performing appended information edit processing and supplying the obtained image data to a print device, a storage device for storing the document data on a storage medium such as flash memory or a CD-ROM, or the like.

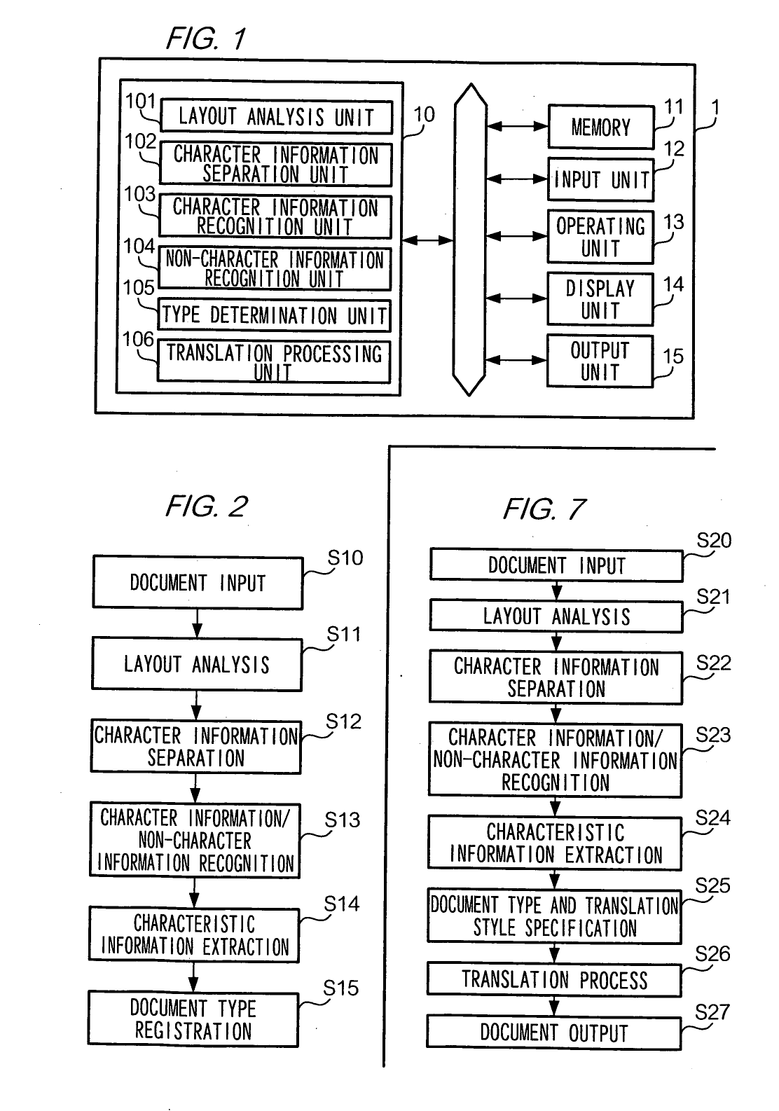

Below, the successive flow of translation processing is explained using FIG. 2 through FIG. 6. In the present embodiment, first, before designating a translation target document, information is registered for specifying the type of the document (characteristic information), the type of the document to be translated is specified using this characteristic information, and a translation style is determined based on the specified type. Therefore, registration processing of the characteristic information will first be explained.

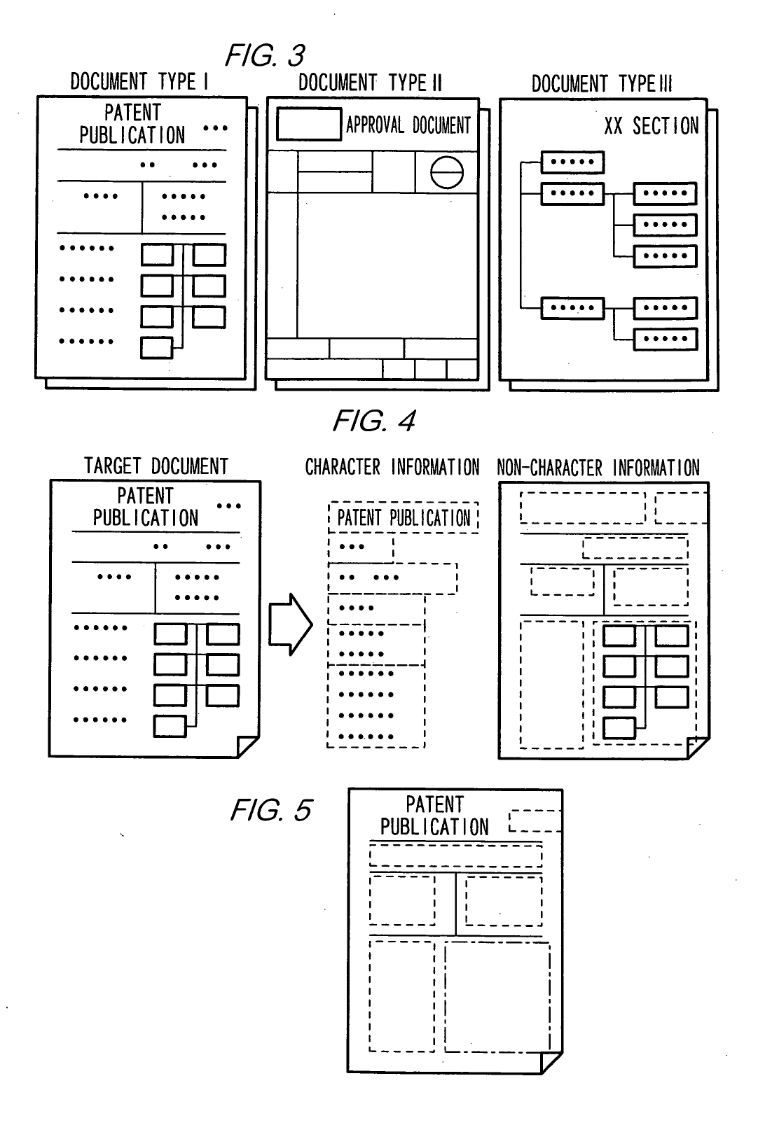

FIG. 2 shows the flow of characteristic information registration processing. As shown in this drawing, first, the user sets a document belonging to the document type that he would like to register (hereinafter, “sample document”) in a scanner device, that document is read and image data is obtained (Step S10). FIG. 3 shows examples of a document type. For example, if the user would like to register a document as the type “patent publication”, the user sets a desired patent publication in the scanner device. Returning to FIG. 2, layout processing of the document is performed next in Step S11, determining the document layout structure, and in Step S12 character information separation processing is performed, separating and extracting character information. Next, character information discrimination processing and non-character information discrimination processing is performed for the document in Step S13, extracting character information and non-character information. FIG. 4 shows an example of extracted character and non-character information.

Returning to FIG. 2, characteristic information of the document is extracted using a predetermined algorithm in Step S14. Roughly speaking, the extracted characteristic information includes information related to the layout structure obtained in Step S11, and information related to the character information obtained in Step S13. Characteristics related to the layout structure include, for example, the presence of ruled lines, the type of ruled line (line type, line thickness, pattern), the presence and arrangement of figures such as graphs and charts, headers/footers, the arrangement of letterhead, columns, vertical/horizontal text, the number of layout blocks, arrangement pattern, size, shape, and color (ratio of color used, etc.), and when there is an image, image characteristics (seal, pattern, etc.). Characteristics related to character information includes, for example, information such as the presence of specified characters in the title of the document (or a portion of the document; for example, “patent publication”, “financial statement”, “approval request”, and the like), name, letterhead, the presence of specified characters in headers/footers, terminology included in texts, the presence or frequency of occurrence of specified proper nouns, the presence or frequency of occurrence of numerals or special symbols, the ratio of character types (numerals, Japanese hiragana, Japanese kanji, roman alphabet, etc.), and character attributes (size, color, typeface, etc.). FIG. 5 shows an example of extracted characteristic information. In this example, the information that “patent publication” is present in the title and is arranged in a predetermined font size, the position of ruled lines, and the arranged position of layout blocks (an arrangement wherein there is one column directly under the title, and two columns continuing beneath that) are extracted as characteristic information that defines the type of document.

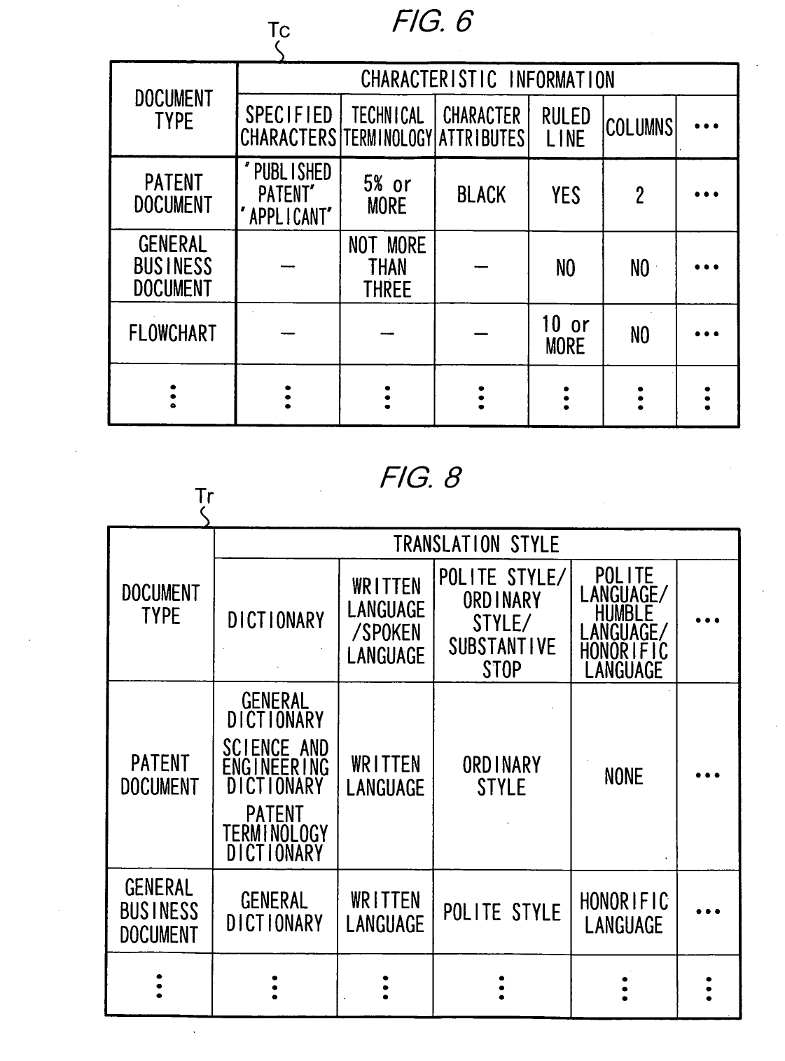

Returning to FIG. 2, when the predetermined characteristic information is extracted in Step S14, the type of text is registered in Step S15. Specifically, a message such as “Extraction of characteristic information for the text is complete. Please register a name for this text type.” is displayed in the display unit 14, and prompts the user to enter a type name. When the user enters a desired type name (for example, “patent document”), this type name is associated with the extracted characteristics and stored in a table Tc in the memory 11. Thus, the type of text and characteristic information are associated on a one-to-one basis. An example of the stored contents of the table Tc is shown in FIG. 6.

Further, the processing of Steps S10 through S15 described above may be performed for other sample texts as necessary. As a result, for example, the characteristic information “objects such as solid lines and enclosing lines are compared to numerals and included in a predetermined ratio” and a document type name “chart, etc.” are associated and registered. In this way, the user repeatedly performs the processing of Steps S10 through S15 as necessary, for each of the document types that the user wants to register in the document processing device 1, and completes the registration operation. The user may also input the same type of sample document multiple times, and register the common characteristics of the characteristic information.

Next, the operation of the document processing device 1 when performing translation processing of the document will be explained. FIG. 7 shows the flow of the translation processing of the document performed after the registration processing described above is completed. As shown in FIG. 7, first, the user sets the document that will be the target of translation processing in a scanner device; thereby enabling the document processing device 1 to read the document (Step S20). When this is done, in the same manner as the Steps S11 through S14 of registration processing, layout processing (Step S21), character information separation processing (Step S22), and character information recognition processing and non-character information recognition processing (Step S23) are executed in the document processing device 1, and characteristic information is extracted in Step S24.

Next, the type of document is specified in Step S25. Specifically, the type determination unit 105 compares the characteristic information extracted in Step S24 and all of the characteristic information registered in the memory 11. Then, the registered document type corresponding to the characteristic information with the greatest similarity is determined as the document type of the document. Then, referring to a table Tr, the translation style is determined according to the determined document type. FIG. 8 shows the stored content of this table Tr. As shown in the same figure, in the table Tr, the document type of a particular document is associated with a translation style that should be applied when translating that document, and stored. For example, a method is registered that is associated with the document type “patent document”, and wherein for the various items “written language/spoken language”, “polite style/ordinary style/substantive stop”, and “polite language/humble language/honorific language” of the translation style and dictionary to be used, “general dictionary, science and engineering dictionary, patent terminology dictionary”, “written language”, “ordinary style”, and “none” respectively exist in the table. This means that ordinary style will be used when translating a document whose document type has been determined to be a patent publication. In this way, by referring to the table Tr, the translation style is uniquely specified from the identified document type.

Next, translation processing is performed for the character information of the document, using the translation style designated in Step S26. The results of the translation are displayed in the display unit 14, and output as digital data according to predetermined instructions from the user or print out on paper or the like (Step S27).

In this way, according to the present embodiment, the document type is specified from the characteristics of the document that will be the translation target, after associating the document characteristics (characteristic information) with the document type and registering them in advance, and because the translation style most suitable for that document can be determined from the specified document type, it is possible to improve the quality of the translation.

### Modified Embodiment

The present invention is not restricted to the embodiment described above; various modifications are possible. Below, a modified embodiment is disclosed. In the embodiment described above, a translation style that includes information about a dictionary to be used and the like is determined when a document type is specified; however, it is not necessary to perform character recognition processing when a document type is determined; character recognition processing may be performed using a dictionary specified as a result of determination of a translation style. Because the accuracy of the character recognition processing may differ according to the dictionary that is used, by selecting the dictionary used when performing character recognition processing according to the document type in this way, it is possible to improve the accuracy of the extracted character recognition. Even in the case of performing character recognition processing as in the embodiment described above and determining a document type, character recognition processing may be performed again using the optimum dictionary determined from the identified document type. In this case, it is possible to further improve the character recognition accuracy.

Also, the content of the sample document and the characteristic information extracted from the sample document are not restricted to the items stated above. It is possible to read a sample document multiple times, extract common learned characteristic items, and register those items. Furthermore, instead of extracting characteristic information by scanning the document, it is also possible to determine a document type or translation style for the translation target, by storing a document template in the document processing device 1 as characteristic information and comparing the layout structure or the like of the document to be translated with the structure of the document template.

Also, when judging the similarity of the characteristic information with the type determination unit 105, all items of characteristic information may be used, or a portion of the items may be selected and used. The method of determining the accuracy of the registered characteristic information and the characteristic information of the text of the translation target, and the method that determines the document type from the similarity, are both optional. For example, it is possible to provide a threshold value for the similarity of each item, and judge that those items match when the threshold value is exceeded. It is also possible to confer a priority ranking to each document type, and when matching the characteristics of multiple document types, determine one document type according to the priority ranking. Also, it is possible to adopt a configuration wherein the user can freely rewrite the characteristic information used for registration processing of the document type.

With respect to the registration of the translation style (the type of dictionary used, etc.) as well, the content and designated method are optional. For example, the contents of the table Tr may be rewritable by the user. Furthermore, instead of having a user write to the table Tr, it is also possible in the document processing device 1 to extract nouns from the character information obtained by the character recognition processing, extract technical terminology included among those nouns using predetermined general dictionaries, associate the dictionary containing the greatest amount of that technical terminology with the document type of the document, and register that information. In this case, the time required for the user's registration operation is reduced.

In order to address the issues described above, the present invention provides a translation processing method that includes: inputting a document; extracting characteristic information from the input document; selecting a translation style according to the characteristic information; and translating the input document using the selected translation style. According to the method of the present invention, the quality of translation is improved because a suitable translation style is selected according to the type of document.

In an embodiment of the present invention, information related to the layout structure of the document is included in the characteristic information. Furthermore, specific character information is included in the characteristic information. Furthermore, the translation style is selected using a table defining a correspondence between the translation style and the characteristic information. Furthermore, the translation style designates a dictionary used in the translating step.

From another point of view, the present invention provides a document processing device including: an input section that inputs a document; an extracting section that extracts characteristic information from the input document; a select section that selects a translation style according to the characteristic information; and a translation section that translates the input document using the selected translation style.

From still another point of view, the present invention provides a storage medium readable by a computer, the storage medium storing a program of instructions executable by the computer to perform a function including: inputting a document; extracting characteristic information from the input document; selecting a translation style according to the characteristic information; and translating the input document using the selected translation style.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments, and with the various modifications as are suited to the particular use contemplated. It is intended that the scope of the invention be defined by the following claims and their equivalents.

The entire disclosure of Japanese Patent Application No. 2005-90202 filed on Mar. 25, 2005 including specification, claims, drawings and abstract is incorporated herein by reference in its entirety.

What is claimed is:

1. A translation processing method comprising:
inputting a document;
extracting characteristic information from the input document;
selecting a translation style according to the characteristic information; and
translating the input document using the selected translation style.

2. The translation processing method according to claim 1, wherein information related to the layout structure of the document is included in the characteristic information.

3. The translation processing method according to claim 1,
wherein specific character information is included in the characteristic information.

4. The translation processing method according to claim 1, wherein the translation style is selected using a table defining a correspondence between the translation style and the characteristic information.

5. The translating processing method according to claim 1, wherein the translation style designates a dictionary used in the translating step.

6. A document processing device comprising:
an input section that inputs a document;
an extracting section that extracts characteristic information from the input document;
a select section that selects a translation style according to the characteristic information; and
a translation section that translates the input document using the selected translation style.

7. The document processing device according to claim 6, wherein information related to the layout structure of the document is included in the characteristic information.

8. The document processing device according to claim 6, wherein specific character information is included in the characteristic information.

9. The document processing device according to claim 6, wherein the translation style is selected using a table defining a correspondence between the translation style and the characteristic information.

10. The document processing device according to claim 6, wherein the translation style designates a dictionary used in the translation section.

11. A storage medium readable by a computer, the storage medium storing a program of instructions executable by the computer to perform a function for document translation, the function comprising:
inputting a document;
extracting characteristic information from the input document;
selecting a translation style according to the characteristic information; and
translating the input document using the selected translation style.

12. The storage medium according to claim 1, wherein information related to the layout structure of the document is included in the characteristic information.

13. The storage medium according to claim 1, wherein specific character information is included in the characteristic information.

14. The storage medium according to claim 1, wherein the translation style is selected using a table defining a correspondence between the translation style and the characteristic information.

15. The storage medium according to claim 1, wherein the translation style designates a dictionary used in the translating process.
